(19) United States
(12) Patent Application Publication
(10) Pub. No.: US 2013/0232310 A1
(43) Pub. Date: Sep. 5, 2013

(54) ENERGY EFFICIENCY IN A DISTRIBUTED STORAGE SYSTEM

(71) Applicant: NEC LABORATORIES AMERICA, INC., Princeton, NJ (US)

(72) Inventor: Erik Kruus, Hillsborough, NJ (US)

(73) Assignee: NEC LABORATORIES AMERICA, INC., Princeton, NJ (US)

(21) Appl. No.: 13/690,940

(22) Filed: Nov. 30, 2012

Related U.S. Application Data
(60) Provisional application No. 61/606,639, filed on Mar. 5, 2012.

(51) Int. Cl. G06F 12/16; G06F 12/02

(52) U.S. Cl. CPC G06F 12/16; G06F 12/0253
USPC 711/162

(57) ABSTRACT

A system for providing block layout in a distributed storage system. A request receiver receives requests to perform a read or write operation for a data block. A memory device stores ordered replica lists and a swap policy. Each list is for a respective stored data block and has one or more entries specifying prioritized replica location information associated with storage devices and priorities there for. A load balancer scores and selects an original location for the data block specified in a request responsive to the information and a policy favoring fully operational storage devices having higher priority locations. The swap policy evaluates the original location responsive to the information and estimated workload at storage device locations to decide upon at least one alternate location responsive to the write operation, and to decide to place the data block at the at least one alternate location responsive to the read operation.

### RELATED APPLICATION INFORMATION

This application claims priority to provisional application Ser. No. 61/606,639 filed on Mar. 5, 2012, incorporated herein by reference.

### BACKGROUND

1. Technical Field

The present invention relates to distributed storage, and more particularly to energy efficiency in a distributed storage system.

2. Description of the Related Art

One common approach to providing energy efficiency in a distributed storage system is to adapt the storage by analyzing statistics gathered during a lengthy epoch (e.g., every day, every 2 hours, every 30 minutes, and so forth), deciding an alternate data layout, and commencing data rearrangement (replication/migration) at such intervals (epochs). However, such techniques may disadvantageously fail to respond quickly to changing client input/output (I/O) behavior and may incur extra I/O during the response to reread data items no longer easily available.

Other approaches to providing energy efficiency in a distributed storage system create copies of the most frequent data, whose original locations remain unchanged. This approach needlessly constrains the layout of data within the storage space to configurations which may be quite inefficient.

Still other approaches to providing energy efficiency in a distributed storage system provide systems for online block exchange based again on frequency data, yet disadvantageously fail to address options for placement and replication.

Yet other approaches to providing energy efficiency in a distributed storage system involve dealing with replica lists, but from the point of view of assigning machines to hot and cold pools (also, typically associated with epoch-based adaptation schemes and, thus, having the aforementioned deficiencies associated therewith).

### SUMMARY

These and other drawbacks and disadvantages of the prior art are addressed by the present principles, which are directed to energy efficiency in a distributed storage system.

According to an aspect of the present principles, there is provided a system. The system is for providing an energy efficient block layout in a distributed storage system. The system includes a client request receiving device for receiving incoming client requests to perform any of a read and write operation for a data block. The system further includes at least one memory device for storing ordered replica lists and a swap policy. Each of the ordered replica lists is for a respective one of stored data blocks in the distributed storage system and has one or more entries. Each of the entries specifies prioritized replica location information for the respective one of the stored data blocks. At least a portion of the prioritized replica location information is associated with physical storage devices and respective priorities for the physical storage devices. The system also include a load balancer for scoring and selecting an original location for the data block specified in a given one of the incoming client requests responsive to the prioritized replica location information and a policy of favoring any of the physical storage devices that are fully operational and have locations of higher priority in the ordered replica lists. The swap policy evaluates the selected original location for the data block responsive at least in part to the prioritized replica location information and estimated input and output workload at locations of the physical storage devices to decide upon at least one alternate location for the data block responsive to the write operation requested for the data block, and to decide to place the data block at the at least one alternate location responsive to the read operation requested for the data block.

According to another aspect of the present principles, there is provided a method. The method is for providing an energy efficient block layout in a distributed storage system. The method includes receiving incoming client requests to perform any of a read and write operation for a data block. The method further includes storing, in at least one memory device, ordered replica lists and a swap policy. Each of the ordered replica lists is for a respective one of stored data blocks in the distributed storage system and has one or more entries. Each of the entries specifies prioritized replica location information for the respective one of the stored data blocks. At least a portion of the prioritized replica location information is associated with physical storage devices and respective priorities for the physical storage devices. The method also includes performing load balancing by scoring and selecting an original location for the data block specified in a given one of the incoming client requests responsive to the prioritized replica location information and a policy of favoring any of the physical storage devices that are fully operational and have locations of higher priority in the ordered replica lists. The swap policy evaluates the selected original location for the data block responsive at least in part to the prioritized replica location information and estimated input and output workload at locations of the physical storage devices to decide upon at least one alternate location for the data block responsive to the write operation requested for the data block, and to decide to place the data block at the at least one alternate location responsive to the read operation requested for the data block.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating an exemplary processing system 100 to which the present principles may be applied, according to an embodiment of the present principles;

FIG. 2 shows an exemplary distributed storage system 200, in accordance with an embodiment of the present principles;

FIG. 3 shows an exemplary method 300 for replica list maintenance for a client read request, in accordance with an embodiment of the present principles;

FIG. 4 shows an exemplary method 400 for replica list maintenance for a client write request, in accordance with an embodiment of the present principles;

FIG. 5 shows an exemplary method 500 for determining the swap policy impact on replica list position of a client (MRU) block, in accordance with an embodiment of the present principles; and

FIG. 6 shows the major components 600 of an energy-efficiency Simulator (EEffSim), in accordance with an embodiment of the present principles.

### DETAILED DESCRIPTION OF PREFERRED EMBODIMENTS

The present principles are directed to energy efficiency in a distributed storage system. In an embodiment, we wish to distribute stored data (“blocks”) such that client requests can be directed to few disks most of the time, allowing other disks to enter low power states to conserve energy during their lengthened idle periods.

To that end, we provide the following. In an embodiment, we provide a method to decide whether to accept or modify block layout on a per-request basis (no epoch: in an embodiment, we render the decision online, with data layout modification initiated within, for example, 20 seconds of receipt of the client request). To that end, we provide fully dynamic data placement options (and, thus, no static “primary” data location, and the deficiencies associated therewith).

We also provide a natural fallback from block replication (preferred, for lowest impact on ongoing client operations) to full block swap. We do not rely upon any assumption of hot or cold disk pools (although such may appear spontaneously in operation) by means of a prioritized replica list as one input to a load balancer which selects a reasonable original destination from available destinations, favoring devices which are fully operational (“ON”) and higher priority positions in the replica list, with simple methods to maintain and update the replica list. For example, one method to maintain and update the replica list is a swap policy that fixes “bad” things (e.g., one or more of the following: (a) too high an I/O load to a particular machine or grouping of machines; (b) too low an I/O rate to make keeping a machine operating in a high-power mode worthwhile; (c) a desire to better collocate or distribute blocks of a particular client; (d) various other system monitoring metrics such as being within normal operating regime for CPU usage, recent read or write I/O latencies, the number of outstanding or incomplete I/O requests directed toward a machine, device hardware problems or other system “heartbeat” failures; and (e) system operator inputs such as a desire to remove a device from operation). For example, according to an embodiment of the swap policy, when necessary, and if a better destination[s] for an original destination is determined, and the better destination requires a new write or replication or full block swap, then the better destination[s] becomes (move or prepend) the highest-priority item in the replica list.

In an embodiment, the replica list is ordered and is interchangeably referred to herein as an “ordered replica list”. Each stored data block in the distributed storage system can have a corresponding ordered data list created therefor. Each ordered replica list can have one or more entries, where each of the entries specifies prioritized replica location information associated with physical storage devices and respective priorities for the physical storage devices. Thus, with respect to the phrase “prioritized replica location information”, priority within such prioritized replica location information can be determined via position within the ordered replica list and/or data components within the entry itself (e.g., one or more additional bits specifying, e.g., some scalar value for priority, and so forth).

We additionally provide a garbage collector 242 which is allowed to erase replicas, preferring to erase replicas of lower priority according to the current replica list position. To that end, newly written blocks can erase old replica information, replacing the former replica list

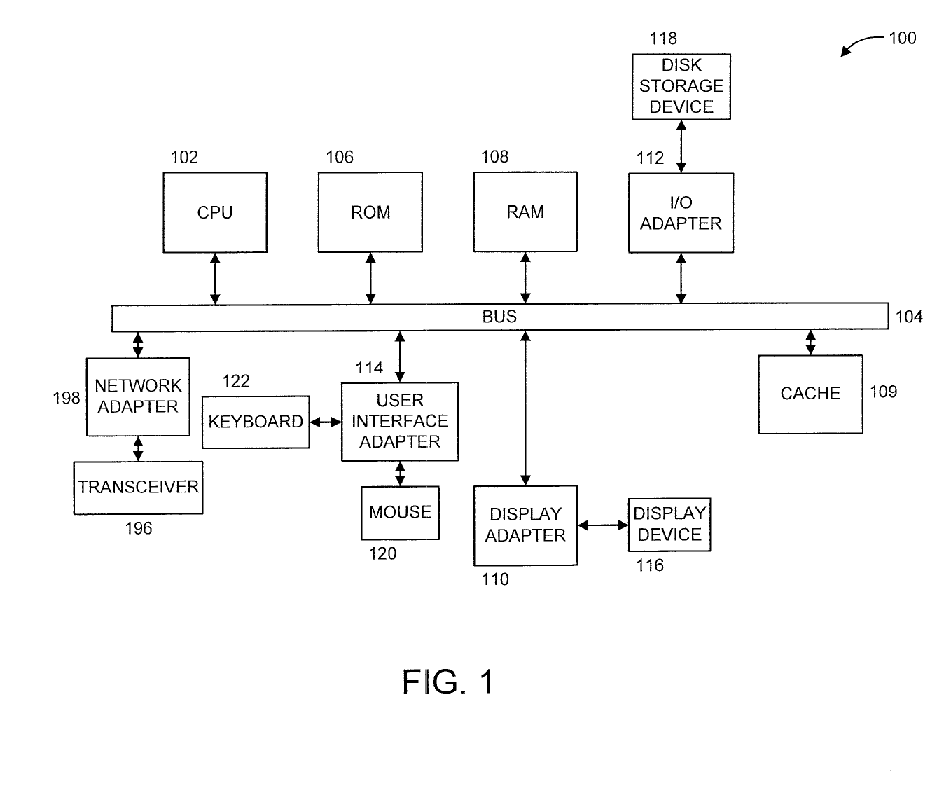

Referring now in detail to the figures in which like numerals represent the same or similar elements and initially to FIG. 1, a block diagram illustrating an exemplary processing system 100 to which the present principles may be applied, according to an embodiment of the present principles, is shown. The processing system 100 includes at least one processor (CPU) 102 operatively coupled to other components via a system bus 104. A read only memory (ROM) 106, a random access memory (RAM) 108, a display adapter 110, an input/output (I/O) adapter 112, a user interface adapter 114, and a network adapter 198, are operatively coupled to the system bus 104.

A display device 116 is operatively coupled to system bus 104 by display adapter 110. A disk storage device (e.g., a magnetic or optical disk storage device) 118 is operatively coupled to system bus 104 by I/O adapter 112.

A mouse 120 and keyboard 122 are operatively coupled to system bus 104 by user interface adapter 214. The mouse 120 and keyboard 122 are used to input and output information to and from system 100.

A transceiver 196 is operatively coupled to system bus 104 by network adapter 198.

Of course, the processing system 100 may also include other elements (not shown), as well as omit certain elements, as readily contemplated by one of skill in the art, given the teachings of the present principles provided herein. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

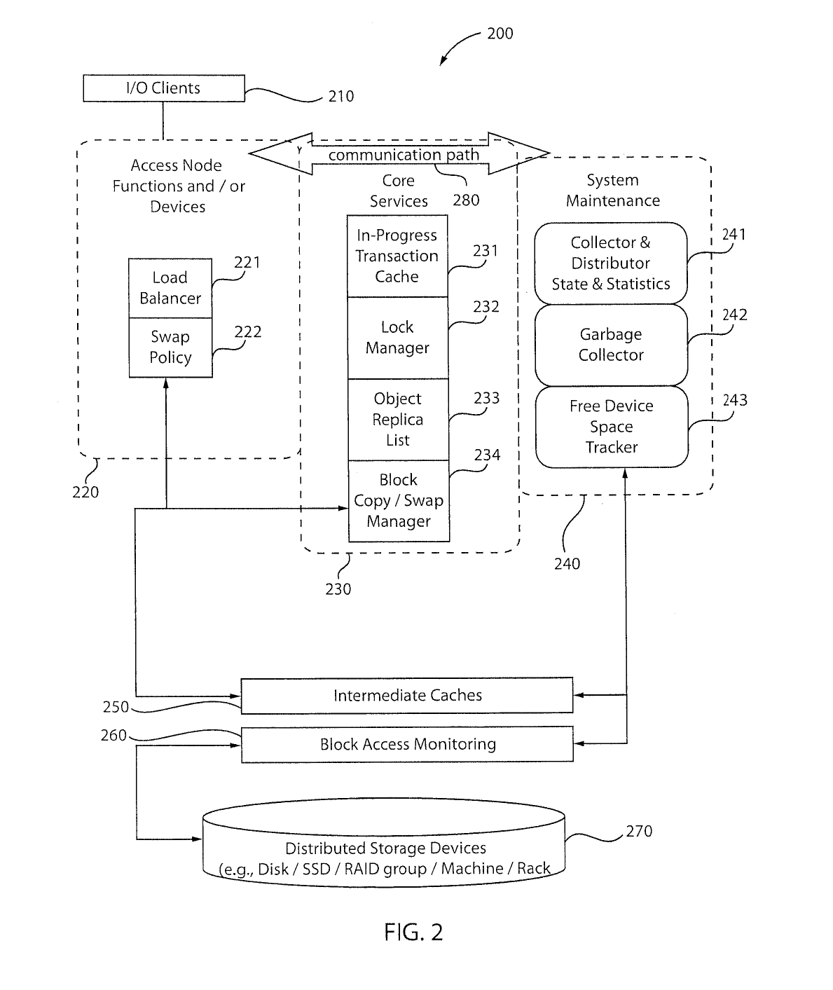

Moreover, it is to be appreciated that system 200 described below with respect to FIG. 2 is a system for implementing respective embodiments of the present principles. Part or all of processing system 100 may be implemented in one or more of the elements of system 200.

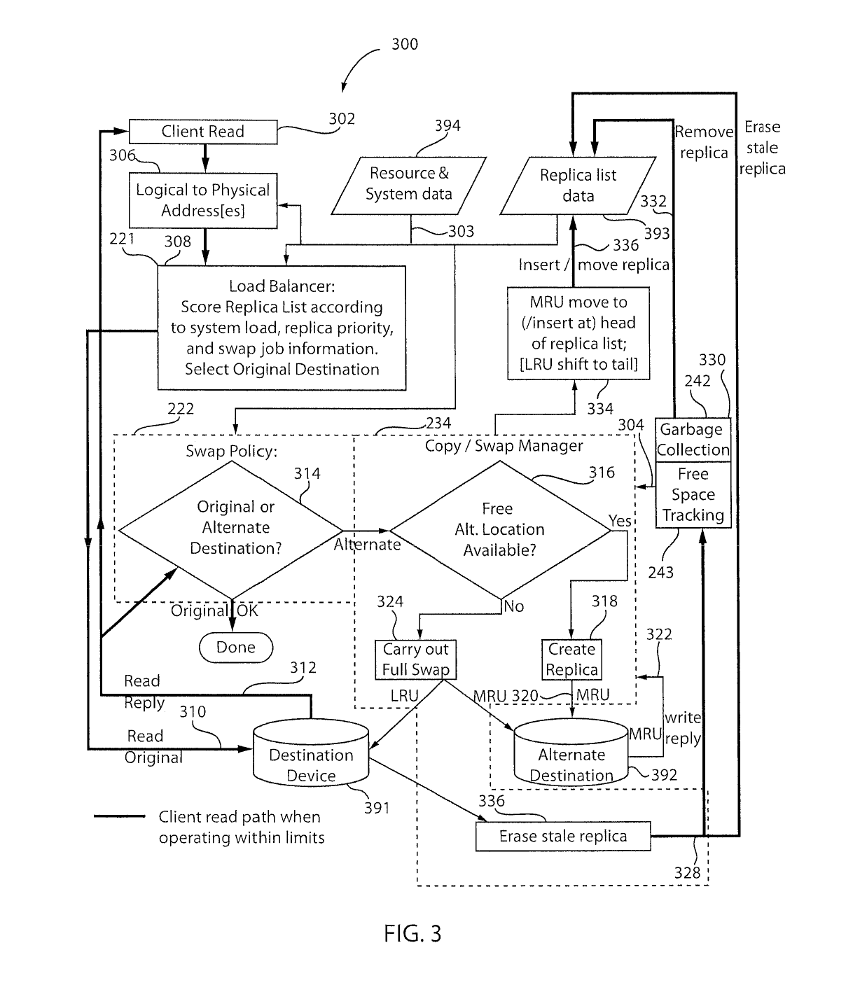

Further, it is to be appreciated that processing system 100 may perform at least part of the method described herein including, for example, at least part of method 300 of FIG. 3. Similarly, part or all of system 200 may be used to perform at least part of method 300 of FIG. 3.

FIG. 2 shows an exemplary distributed storage system 200, in accordance with an embodiment of the present principles. The system 200 includes I/O clients 210, access node functions and/or devices 220, core services 230, system maintenance portion 240, intermediate caches 250, block access monitoring 260, and distributed storage devices 270. A communication path 280 interconnects at least the access node functions and/or devices 220, the core services 230, and the system maintenance portion 240.

The access node functions and/or devices 220 include a load balancer 221 and a swap policy 222. It is to be appreciated that the swap policy 222 may also be interchangeably referred to herein as a swap policy manager, which is to be differentiated from the block copy/swap manager 234. However, in some embodiments, the functions of both the swap policy 222 and the block copy/swap manager 234 may be subsumed by a single device referred to as a swap policy manager, given the overlapping and/or otherwise related functions of the swap policy 222 and the block copy/swap manager 234.

The core services include an in-progress transaction cache 231, a lock manager 232, an object replica list 233, and a block copy/swap manager 234.

The system maintenance portion 240 includes a collector and distributor of state and statistics 241, a garbage collector 242, free device space tracker 243.

The distributed storage devices 270 can include, but are not limited to, for example, disks, solid-state drives (SSDs), redundant array of independent disks (RAID) groups, a storage machine, a storage rack, and so forth. It is to be appreciated that the preceding list of distributed storage devices is merely illustrative and not exhaustive.

Of course, the system 200 may also include other elements (not shown), as well as omit certain elements, as readily contemplated by one of skill in the art, given the teachings of the present principles provided herein. The elements of system 200 depicted in FIG. 2 are described in further detail hereinafter.

FIG. 3 shows an exemplary method 300 for replica list maintenance for a client read request, in accordance with an embodiment of the present principles. Thus, FIG. 3 shows a conceptual path for the client read request. However, it is to be appreciated that causality, overlapping of operations in time, and failure handling are not represented in the example of FIG. 3 for the sakes of brevity and clarity.

At step 302, a client read request is received.

At step 303, both resource and system data 394 and replica list data 393 (stored in replica list 233) are provided to step 306, the load balancer 221, and the swap policy 222.

At step 304, free space tracking data is provided from the free device space tracker 243 to the copy/swap manager 234.

At step 306, a conversion is performed from a logical address(es) to a physical address(es).

At step 308, load balancing is performed, involving scoring a replica list according to system load, replica priority, and swap job information. Load balancing also involves selecting an original destination.

At step 310, a read is performed from a destination device 391 according to the selected original destination.

At step 312, a read reply is sent from the destination device 391 to the swap policy 222 and responsive to the client read request of step 302.

At step 314, the swap policy 222 determines whether the read from the original destination device 391 (i.e., use the results from step 310) may have been better served from an alternate destination device 392. That is, if the swap policy 222 determines that the read from the original destination device 391 was within normal operating parameters (i.e. in accord with desired system resources and system data 394), then the results from step 310 are used, and the method is terminated. Otherwise, if the swap policy 222 determines a preferable alternate destination device 392, from which future reads may potentially be advantageously served, then the method proceeds to step 316.

At step 316, the block copy/swap manager 234 determines whether there is a free alternate location available on the selected alternate destination device. If so, then the method proceeds to step 318. Otherwise, the method proceeds to step 324.

At step 318, a replica is created.

At step 320, the replica is written to the alternate destination device 392 and this newly written replica of the client read data is denoted as “MRU”.

At step 322, a MRU write reply is sent from the alternate destination device 392 to the copy/swap manager 234.

At step 324, a full swap is carried out (performed). If the full swap is performed using a LRU policy, then a least-recently used block “LRU” is selected on the alternate destination device 392. Then the full swap is performed with respect to the original destination device 391 as follows: (a) the original “MRU” data of 392 is written to a storage location on 391; and (b) the “LRU” data of 391 is written to a storage location on 392. The data labeled “LRU” may of course be selected according to other common caching algorithms such as random, first in, first out (FIFO), least frequently used (LFU), CLOCK, and so forth.

At step 326, a stale replica (corresponding to, for example one or more of: (a) the original “LRU” block location on alternate destination 392 after completion of full swap 324; or (b) the original “MRU” block location on destination device 391 after completion of full swap 324 to a copy of MRU data; and (c) data movement and space recovery initiated by free space tracker 243 and garbage collector 242) is erased from the original destination device 391.

At step 328, an acknowledgement of the erasing of the stale replica is sent to the free device space tracker 243 and to the replica list data 393 stored in the replica list 233.

At step 330, garbage collection is performed. This may entail erasure of stale replicas 326 in accordance with a desire to remove unused excess replicas to maintain a reserve of free space on each storage device.

At step 332, replica removal data is sent from the garbage collector 242 to the replica list data 393 stored in the replica list 233 (e.g., relating to the stale replica removed at step 326).

At step 334, data relating to an MRU move is generated for insertion at the head of the replica list and data relating to an LRU move is generated for insertion at the tail of the replica list. The MRU movement to the head of the list may be used to indicate to load balancer 221 a replica priority favoring routing of future client I/O for the logical address of client request 302 to be served from alternate destination 392. Conversely, placing the moved LRU to the tail of its replica list may be used to disfavor selection of the LRU block written to destination device 391 in favor of other replica locations for the LRU block.

At step 336, the data generated at step 334 is provided to the replica list data stored in the replica list 233.

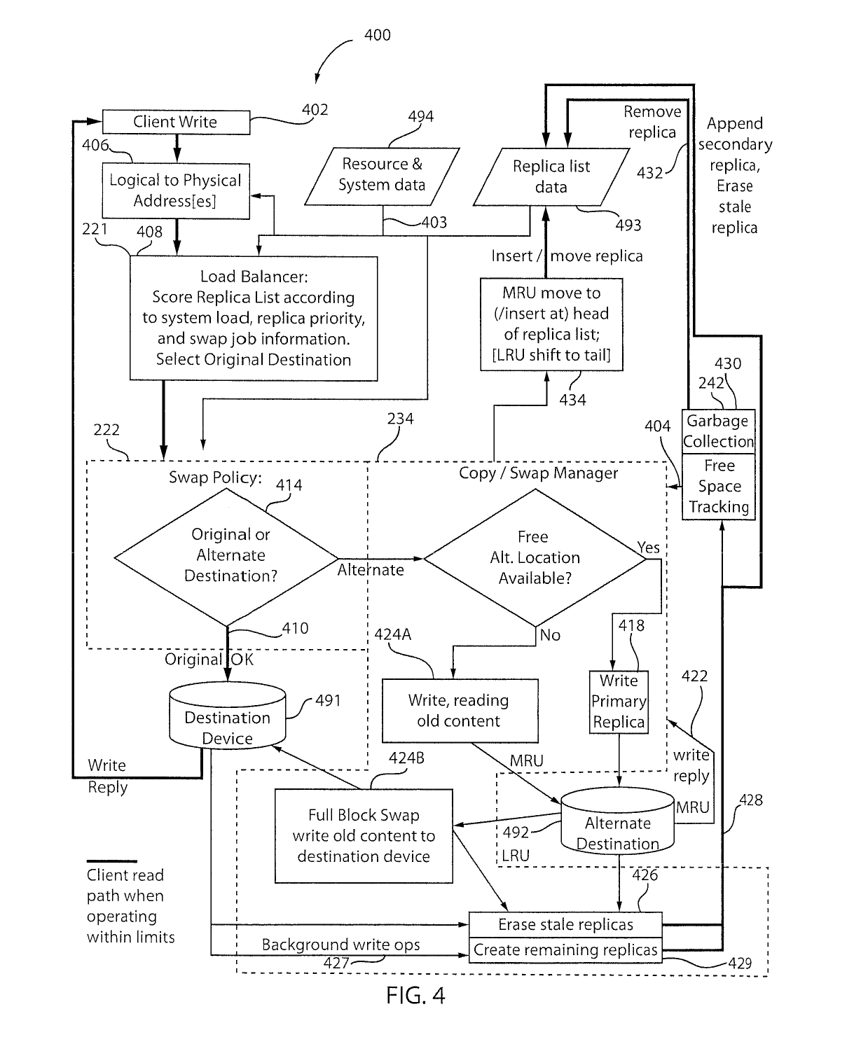

FIG. 4 shows an exemplary method 400 for replica list maintenance for a client write request, in accordance with an embodiment of the present principles. Thus, FIG. 4 shows a conceptual path for the client write request. However, it is to be appreciated that causality, overlapping of operations in time, and failure handling are not represented in the example of FIG. 4 for the sakes of brevity and clarity.

At step 402, a client write request is received.

At step 403, resource and system data 494 and replica list data 493 (stored in the replica list 233) are provided to step 406, the load balancer 221, and the swap policy 222.

At step 404, free space tracking data is provided from the free device space tracker 243 to the copy/swap manager 234.

At step 406, a conversion is performed from a logical address(es) to a physical address(es).

At step 408, load balancing is performed, involving scoring a replica list according to system load, replica priority, and swap job information. Load balancing also involves selecting an original destination.

At step 414, the swap policy 222 determines whether or not to perform the write to the original destination device 491 or from an alternate destination device 492. If the swap policy 222 determines to perform the write to the original destination device 491, then the method proceeds to step 410. Otherwise, if the swap policy 222 determines to perform the write from the alternate destination device 492, then the method proceeds to step 416.

At step 410, a write is performed to a destination device 491 according to the selected original destination.

At step 412, a write reply is sent from the destination device 491 responsive to the client write request of step 402.

At step 416, the block copy/swap manager 234 determines whether there is a free alternate location available. If so, then the method proceeds to step 418. Otherwise, the method proceeds to step 424.

At step 418, a primary replica of the client write data (denoted “MRU”) is written to the alternate destination device 392.

At step 422, a MRU write reply is sent from the alternate destination device 392 to the copy/swap manager 234. After the MRU write has completed, old replicas of content corresponding to the client write are no longer current and may be reclaimed by erasing such stale replicas from their respective devices during step 426. After all required remaining replicas are successfully written, 429, the original client write, 402, may be acknowledged (arrow not shown) as successfully completed.

At step 424A, a write of client write data “MRU” and a reading of old content “LRU” are performed with respect to the alternate destination device 492. In the alternative, at step 424B, a full block full swap is performed which involves writing the “LRU” content to the original destination device 491, quite possibly chosen to overwrite the stale “MRU” data. Conversely, the “MRU” data may overwrite the original “LRU” storage locations on the destination device 492. This approach to full swap can make progress even if block allocation fails. Otherwise, a more robust swap mechanism may direct writes of the full swap to free areas on the new destination, followed by erasure, 426, of the stale replicas.

At step 426, any stale replicas (corresponding to either the “MRU” data of the write request or to LRU data selected for steps 424A & 424B) are erased from the original destination device 391.

At step 427, background write operations data is sent from the destination device 491 to a step 429.

At step 429, remaining replicas are created, responsive to at least the background write operations data.

At step 428, a secondary replica (created by step 429) is appended to an acknowledgement of the erasing of the stale replicas that is sent to the free device space tracker 243 and to the replica list data 493 stored in the replica list 233.

At step 430, garbage collection is performed.

At step 432, replica removal data is sent from the garbage collector 242 to the replica list data 493 stored in the replica list 233 (e.g., relating to the stale replica removed at step 426).

At step 434, data relating to an MRU move is generated for insertion at the head of the replica list and data relating to an LRU move is generated for insertion at the tail of the replica list. The MRU movement to the head of the list may be used to indicate to load balancer 221 a replica priority favoring routing of future client I/O for the logical address of client request 402 to be served from alternate destination 392. Conversely, placing the moved LRU to the tail of its replica list may be used to disfavor selection of the LRU block written to destination device 391 in favor of other replica locations for the LRU block.

At step 436, the data generated at step 434 is provided to the replica list data stored in the replica list 233.

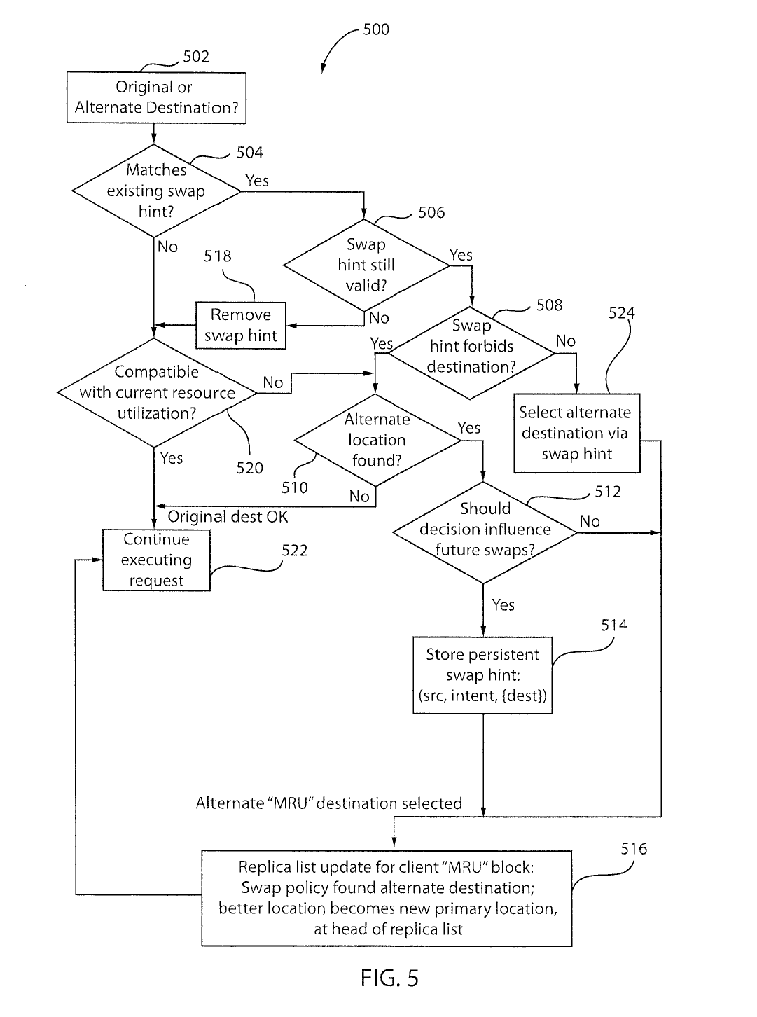

FIG. 5 shows an exemplary method 500 for determining the swap policy impact on replica list position of a client (MRU) block, in accordance with an embodiment of the present principles. Regarding FIG. 5, it is to be noted that replacing an original destination with a better alternate location makes the alternate location the new primary replica. Moreover, it is to be noted that judging a location to be better applies to the “MRU” blocks accessed by the client. Further, it is to be noted that erase operations for client writes are not shown in FIG. 5 for the sakes of brevity and clarity.

At step 502, it is determined whether an implicated destination in a client request is an original destination or an alternate destination. Step 502 may be undertaken, for example, during Swap Policy steps 314 for client reads or 414 for client writes. Similar processing may also be invoked during system maintenance functions 200, such as by garbage collector 242.

At step 504, a result of step 502 is compared to an existing swap hint and it is then determined whether the result of step 502 matches the existing swap hint. If so, then the method proceeds to step 506. Otherwise, the method proceeds to step 520.

At step 506, it is determined whether the swap hint is still valid. For example, resource and system data, 394 or 494, may indicate that the resource conditions motivating the creation of the swap hint have subsided. If the swap hint is still valid, then the method proceeds to step 508. Otherwise, the method proceeds to step 518.

At step 508, it is determined whether any other swap hint forbids the destination (determined by step 502). For example, one may wish to limit the number of swap hints directing I/O traffic to a particular machine, or check that a swap hint destination has not also been recently been tagged as a swapping source. If other swap hints forbid this destination, then the method proceeds to step 510. Otherwise, the method proceeds to step 524.

At step 510, a suitable alternate location is searched for based on current system resources (394 or 494) and current replica location data (393 or 493). If a suitable alternate location has been found, then the method proceeds to step 512. Otherwise, the method proceeds to step 522.

At step 512, it is determined whether the decision (of alternate location) should influence future swaps. If so, then the method proceeds to step 514. Otherwise, the method proceeds to step 516.

At step 514, the persistent swap hint is created. In an embodiment, it comprises a triplet (src, intent, {dest}), where “src” denotes a particular client destination device (391 or 491), “intent” denotes “a specification of an intent of a corresponding swap job applicable to a given one of the stored blocks”, and “{dest}” denotes a preferred destination (392 or 492). A swap policy 222 may honor swap hints by redirecting client reads, 202, or client writes, 402, to alternate devices during decision steps 314 and 414. The “intent” field may indicate several reasons for creation of a swap hint, such as: “src I/O load too high”, “src I/O load too low”, “src latency too high”, or any other system indicator chosen to represent system operation outside an established normal regime. A swap hint is invalidated, for example, in step 506 when the abnormal “intent” has been rectified. A swap hint may also be invalidated if the destination enters an abnormal operating regime. Swap hints may be used to create a more consistent set of responses to I/O overloads, for example, within swap policy 222. One can appreciate that alternative approaches to implement step 502 of a swap policy 222 may also be used. In particular, a probabilistic redirection of data according to currently available system resources (“slack”) has also been shown to function well. FIG. 5 represents one of several approaches we have investigated.

At step 516, a replica list update for the client MRU block is performed, where if the swap policy found an alternate location, the better (alternate) location becomes the new primary location, at the head of the replica list. For LRU blocks subjected to a full swap move to the tail of the replica list.

At step 518, the swap hint is removed.

At step 520, it is determined whether the determined destination (by step 502) is compatible with the current resource utilization. If so, then the method proceeds to step 522. Otherwise, the method proceeds to step 510.

At step 522, the execution of the request is continued.

We will now further describe certain aspects of the present principles, primarily with respect to FIGS. 2-5.

The management of the replica list 233 is a significant aspect of the present principles. In an embodiment, the replica list 233, on a per block basis, is principally modified by every swap policy redirection decision. In an embodiment, the load balancer 221 chooses a first location in the replica list 233 that refers to an ON device (or, in an embodiment, attempts real load balancing by choosing amongst several reasonable locations within the current replica list 233, where reasonable in this context may refer to, for example, one or more of the following: (a) sufficient available system resources currently available at the replica location; (b) preference to reuse a most recently used replica location (indicated by position near the head of the replica list, in order to maximize cache hits in any intermediate I/O caches, 250); and (c) the total system I/O load operating in rough proportion to the number of storage devices operating in high-energy mode. The swap policy 222 renders swap policy decisions. For example, in an embodiment, if an I/O destination choice is still deemed bad (based on certain pre-defined criteria, many of which relate to availability of sufficient resources, such as, for example, but not limited to, one or more of: (a) too high an I/O load to a particular machine or grouping of machines; or (b) too low an I/O rate to make keeping a machine operating in a high-power mode worthwhile; or (c) a desire to better collocate or distribute blocks of a particular client; (d) or various other system monitoring metrics such as being within normal operating regime for CPU usage, recent read or write I/O latencies, # of outstanding or incomplete I/O requests directed toward a machine, device hardware problems or other system “heartbeat” failures; (e) or system operator inputs such as desire to remove a device from operation), the swap policy 222 checks to see if there is a better destination choice. If so, then the better place gets first place in the replica list 233 (may have persistent state, such as “intent” of a swap job).

In an embodiment, a garbage collector 242 regenerates free space and removes excess replicas preferring to remove replicas of high replica list index (tail).

In an embodiment, a significant aspect of the present principles is how the load balancer 221, the swap policy 222 and its data creation/migration/swapping cooperate to use and maintain replica list priorities such that more recent modifications end up at the head of the replica list 233. In an embodiment, a significant aspect of the present principles is that more recent fixed up locations are more important than older locations and move to the head of the replica list 233. This procedure is governed primarily by the swap policy and implemented by its block migration and block swapping processes.

When free space and garbage collection are used, the garbage collector 242 erases tail positions in the replica list first. The load balancer 221, which can make an initial selection from among existing replica locations, has read-only access to the replica list entries and its output may then be modified by the swap policy. The swap policy may choose data destinations that are not present within the current replica list 233.

In the illustrative embodiments depicted in FIGS. 3 and 4, the Replica List Data blocks and its update mechanisms (all shown as incoming arrows) represent at least some of the differences of the present principles as compared to the prior art. In an embodiment, a main concept is that more recent fixed up locations are considered more important than older locations and move to the head of the replica list 233. Replica list position does not reflect other “obvious” choices such as most frequent access and/or most recent access, which are very typical prioritizations within caching and replication literature.

The prioritization described herein is believed to be a unique and quite advantageous way to maintain priorities. Moreover, the described online adaptation described herein provides significant advantages over the prior art.

In the FIGURES, one primary benefit provided by the present principles is that when applied, the system quickly adapts and achieves, for a wide range of realistic client I/O patterns, a state in which the swap policy results in very few corrective actions (everything is within operating norms). FIG. 5 shows a swap policy implementation where the bolder arrows denote the usual path of decision making, and it can be noted that only when corrective actions are taken is the replica list 233 updated.

A description will now be given of features of the present principles that provide benefits and advantages over the prior art. Of course, the following are merely exemplary and even more advantages are described further herein below.

In an embodiment, every client request is acted on by the swap policy decision-making. In an embodiment, this is an online algorithm, so it can respond quickly to changes in client I/O patterns.

Being an online algorithm, data to be swapped and/or copied is already available, which can lead to more efficient use of system resources. Were the same operations to be undertaken later, at least some data would need to be reread, leading to a higher number of total I/Os and a potential to negatively impact a client's perception of read and write bandwidth and/or latency.

The swap policy decisions are largely based upon load information, and act so as to move the I/O load at any one location either to within a normal operating range, or to zero. When in steady state, the number of active storage locations is maintained roughly in proportion to the total client I/O load, resulting in energy proportionality. This saves energy and reduces data center operating cost.

In an embodiment, the swap policy only decides to change something if normal operating parameters (e.g., but not limited to, the load at a requested location being too high, too low, and so forth) are exceeded. This maintains costly background adaptation work to either a bare minimum or to some acceptable threshold (the swap policy may also throttle its own activity). This reduces impact on client quality of service (QoS).

In an embodiment, replica list 233 changes are implemented by two entities, namely the swap policy 222 and the garbage collector 242, resulting in code simplicity.

Very little additional data (primarily only regularly updated system load information) is required for a basic implementation, as compared to the prior art epoch based statistical gathering requirements, so the solution scales well.

Thus, while the present principles provide many advantages of the prior art, as is readily apparent to one of ordinary skill in the art, given the teachings of the present principles provided herein, we will nonetheless further note some of these advantages as follows. The present principles save energy while improving or minimally increasing various quality of service measures (such as the number of disk spin-ups, client latency, and so forth). The present principles achieve fast response to non-optimal client access patterns (thus, being more robust and reactive than prior art approaches relating to energy efficient of distributed storage systems). The present principles can be adapted and applied to many different storage scenarios including, but not limited to: block devices, large arrays of RAID drives, Hadoop, and so forth. It is to be appreciated that the preceding list of storage scenarios is merely illustrative and not exhaustive. That is, given the teachings of the present principles provided herein, one of ordinary skill in the art will readily contemplate these and various other storage scenarios and types of distributed storage systems to which the present principles can be applied, while maintaining the spirit of the present principles. Referring back to some of the many attendant advantages provided by the present principles, we note the simplicity of the basic implementation of the method described herein can lead to simpler implementations (higher code quality). Amassing large quantities of statistical data is not fundamental to the function of the method, so the method can readily scale well to distributed systems of large size, as is readily apparent to one of ordinary skill in the art, given the teachings of the present principles provided herein.

We will now describe energy-efficiency Simulator (EEffSim) basics, in accordance with an embodiment of the present principles.

We have been developing and using an in-house simulator to explore the design space for distributed storage systems. Here we review only the major characteristics of this simulator, and focus on the innovative mechanisms we adopted to handle multiple data replicas described hereinafter.

General purpose discrete event simulators are readily available, and may cater to very accurate network modeling, while DiskSim is a tool to model storage devices at the hardware level. Regarding the present principles, we bridge the gap between both.

Regarding quality of service (QoS), in an embodiment, our goal is simply to impose a bound on the fraction of requests that have access times (delays) longer than normal due to a disk drive spinning up. This goal allows us to approximate disk-access latencies to allow fast simulation of large-scale systems. An approximate device model has allowed us to simulate systems with hundreds of disks.

During several years of experience in building and maintaining a large-scale distributed file system, a storage emulator for a distributed back-end object store has been a vital component of unit testing and quality control. Herein, we describe a simulation tool for research and development into new distributed storage system designs. We describe EEffSim, a highly configurable simulator for general-purpose multi-server storage systems that models energy usage and estimates I/O performance (I/O request latencies). EEffSim provides a framework to investigate data migration policies, locking protocols, write offloading, free-space optimization, and opportunistic spin-down. One can quickly prototype and test new application programming interfaces (APIs), internal messaging protocols, and control policies, as well as gain experience with core data structures that may make or break a working implementation. EEffSim also enables reproducibility in the simulated message flows and processing which is important for debugging work. EEffSim is built with the capability to easily vary various policy-specific parameters. EEffSim also models the energy consumption of heterogeneous storage devices including sold state drives (SSDs).

We will now describe some of the design goals of the present principles as they relate to EEffSim, in accordance with an embodiment of the present principles.

As data storage moves towards larger-scale consolidated storage, one must make a decision about which data shall be stored together on each disk. These data placement decisions can be made at a volume level, or with more flexibility and potential for energy savings, at a fine-gained level. We are interested in exploring adaptive, online data placement strategies, particularly for large-scale multi-server storage. An online data placement strategy using block remapping has the potential to consolidate free space. It can take advantage of client access time correlations to dynamically place client accesses similar in time onto similar subsets of disks.

We have adopted simulating the networking and device access time delays in a discrete simulation of message passing events of I/Os as they pass through different layers in the storage stack. One advantage of the message-passing approach is its amenability to support various new metadata. For example, block mapping data, client access patterns, statistics of various sorts, and even simply large amounts of block-related information that can guide data handling policies are supported through the message-passing approach.

EEffSim enables prototyping new block placement policies and SSD-aware data structures to investigate some possible approaches to architecting future large-scale, networked block devices to achieve energy efficient operation by spinning down disk drives. By leveraging SSDs to store potentially massive amounts of statistical metadata, as well as a remapping of the primary block storage location to alternate devices, one could show how block placement strategies form a useful addition to replication strategies in saving disk energy.

Our reasons behind choosing a simple simulation model are presented hereinafter. The simulation speed of an approximate approach makes it feasible to model otherwise intractably large storage systems. In general, our primary concern is comparing different block placement policies rather than absolute accuracy of energy values themselves. Interpretations using the simulator thus concentrate on relative energy values and energy savings of different schemes.

To provide further confidence in our results, we perform sensitivity analysis. For example, if the favored block placement policy can be shown to be insensitive to varying disk speed over a large range, then it is likely to remain the favored policy were disk access to be modeled more accurately. In summary, we will describe a simulator that allows: (1) A framework to compare block placement policies for energy savings and frequency of high-latency events (>1 second); (2) Investigation of novel SSD-friendly data structures that may be useful in real implementations; (3) Speedy simulation (>1×10⁶ messages per second) of very large distributed storage systems using approximations in modeling disk access latencies; and (4) Accuracy in low-IOPS (I/O per s) limit, with good determination of energy savings due to disk state changes.

A description will now be given of an overview of the simulator design, in accordance with an embodiment of the present principles.

Regarding the overview of the simulator design, a description will now be given regarding the simulator architecture, in accordance with an embodiment of the present principles.

Our discrete event driven simulator, EEffSim, is architected as a graph, with each node being an object that abstracts one or multiple storage system components in the real world, for example, a cache, a disk, or a volume manager. The core of our discrete event simulator is a global message queue from which the next event to be processed is selected.

To this standard simulator core we have added support for block swap operations. Clients' access blocks within a logical address range and the block swap operations in the simulator do not change the content of the corresponding logical blocks. Block swapping is transparent to clients since the content located by the logical block address (LBA) remains unchanged, and clients always access through the LBA. Block swaps interfere as little as possible with the fast path of client I/Os. For example, suppose l₁ and l₂ are LBAs and p₁ and p₂ are the corresponding physical block addresses (PBAs). Before block swapping, we have l₁→p₁ and l₂→p₂. After the block swap, we will have l₁→p₂ and l₂→p₁. Block swap operations are a mechanism to co-locate frequently and recently accessed blocks of multiple clients on a subset of active disks, so that infrequently accessed disks can be turned OFF to save energy. Block swaps can also reduce disk I/O burden if the content to be swapped is already present in cache. Note that moving from a static primary location to a fully dynamic logical-to-physical block mapping does have one significant cost, namely more metadata to handle all (versus just a fraction) of storage locations.

The storage objects optionally store a mapping of block-id to content identifier, for verifying correctness of the stored content after block swap operations, and allowing an existence query for other debug purposes. For larger simulations, maintaining content identifiers can be skipped in order to save memory. Note that objects in the simulator are merely representations of a physical implementation, so that (for example) a single Access Node object in the simulator may represent a distributed set of Access Nodes machines, or even proxy client stubs, in reality. Similarly, several data structures in the simulator are simplified versions of what in reality might be implemented as a distributed key-value store, or distributed hash table (DHT). We attempt to get the number of (simulated) network hops approximately correct when implementing our message-passing simulations using such structures.

Regarding the overview of the simulator design, a description will now be given of simulation modules, in accordance with an embodiment of the present principles.

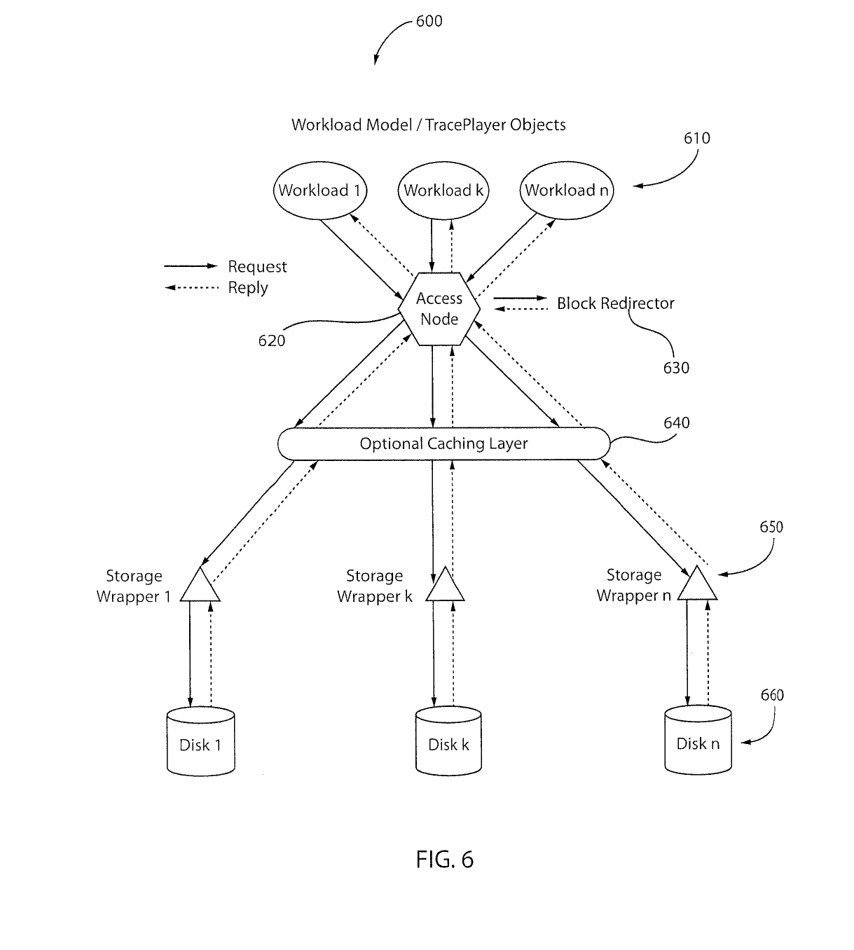

FIG. 6 shows the major components 600 of an energy-efficiency Simulator (EEffSim), in accordance with an embodiment of the present principles. We now describe each of the components.

Regarding the workload model/trace player objects, the workload model objects 610 provide implementations that generate I/O requests. For example, synthetic workload generation can generate I/O requests according to Pareto distribution while trace players 611 replay block device access traces.

Regarding the AccNode Object 620, the AccNode or “access node” object 620 handles receipt, reply, retry (flow control) and failure handling of client I/O messages, which involves the following tasks: (i) simulating the protocol of the client—lock manager that provides appropriate locks for each client's Read/Write/AsyncWrite operations; (ii) translating logical block addresses to physical addresses (by querying the block redirector object); (iii) routing I/O requests to the correct cache/disk destinations; (iv) simulating support to Read/Write/Erase operations on a global cache, which is a rough abstraction of a small cache supporting locked transactions (We utilize this global cache to support our post-access data block swapping as well as write-offloading mechanisms); and (v) simulating the protocol of the client write offloading manager which switches workload to a policy-defined ON disk. In addition, AccNode object also supports simulation of special control message flows for propagating system statistics (e.g., cache adaptation hints for promotion-based caching schemes).

Regarding the block redirector object 630, in general, the same performs the following tasks: (i) maps logical address ranges to physical disks for both default mapping (i.e., the mapping before block swapping) and current mapping (the mapping after block swapping); (ii) supports background tasks associated with block swapping and write offloading. (Our write offloading scheme currently assumes a single step for the read-erase-write cycle in dealing with writing blocks to locations that must have their existing content preserved); (iii) models current physical locations for all logical block addresses; and (iv) using a bit-vector of physical blocks on the device, tracks free blocks, if any, amongst all physical devices.

Regarding the optional cache objects 640, these objects are an abstraction of a content cache. Multilayered caches can optionally be simulated between AccNode and storage wrappers. Particularly, it has two important implementations, namely: Promote-LRU; and Demote-LRU. We have investigated Promote-LRU and Demote-LRU policies that support promotion- and demotion-based caching policies respectively.

Regarding the storage wrapper objects 650, the same include storage device metadata. It is a least recently used (LRU) list of block-ids which wraps all accesses to a single disk. It is a useful component in block swapping schemes, where its main function is to select infrequently used or free blocks.

Regarding a storage object 660, the same models a block-based storage device. It is associated with an energy specification including entries for power in ON and OFF states, transition power per I/O, t_{OFF→ON} (time to turn disk ON, e.g., 15 seconds, or, negligible in case of SSDs), t_{ON→OFF} (idle time, after which a disk turns OFF, e.g., 120 seconds). A storage object also specifies read/write latencies that are internally scaled to approximate random versus sequential block access according to the class (SSD/disk) of storage device.

Regarding the overview of the simulator design, a description will now be given of advantages of using simple models, in accordance with an embodiment of the present principles.

Our simulator uses simple, approximate models primarily for two reasons, namely: simulation speed; and a focus on high-level system design where relative rankings of different design policies matter more than absolute accuracy. Even with a moderate number of software components, building a prototype distributed system takes enormous engineering effort.

Regarding speed, our approach using simple models can achieve simulation speeds of hundreds of thousands of client I/Os per second of simulation time, permitting us to simulate larger systems quickly. Identified design concepts can be used to later implement a single “real” system, for which real statistics (e.g., latency and disk ON/OFF transition information) and power measurements can be gathered.

Regarding flexibility, it is to be noted that the simulator is applicable to more than simply block devices. By changing the concepts of block-id and content, the graph-based message-passing simulation can simulate object stores, file system design, content addressable storage, key-value and database storage structures.

Regarding resources, the simulator saves memory by using place-holders for actual content to test system correctness. One can run larger simulations by providing alternate implementations of some components that forego these tests and do not store content. Another approach to save memory is to scale down the problem appropriately. Both techniques also increase simulation speed as well as utilize less memory.

Regarding rescaling, one rescaling technique we have found useful is to lower by the same factor, the following: client working set sizes; client I/O rates; disk speeds; and disk/cache sizes. When this is done, and one has verified that the rescaling has little or no effect on the relative ordering of predicted energy savings for different policies, one can develop and test new policies on the scaled-down system and verify scaling characteristics later. For several swap policies and one standard set of test clients, the above resealing changed energy estimates <5% when resealed by up to 16×. In other test sets, energy usage of swap policies followed smooth trends while maintaining a largely unchanged ordering of policies. Resealing may help to establish regimes where certain policies work better than others.

To modify the working set size, the raw block numbers were reduced modulo to the desired working set size and segmented (e.g., 12 segments), with segments remapped to cover the underlying device. This retains roughly the same proportions of random versus sequential I/O. The size of random I/O jumps is not maintained, but our policies do not optimize block placement on individual devices, and we are only crudely approximating seek times in any case.

Regarding the overview of the simulator design, a description will now be given regarding energy/power measurements, in accordance with an embodiment of the present principles.

Although we have included energy contributions from all the simulated components (AccNode, caches, storage devices, and so forth), storage device energy is the largest contributor to the total energy usage of the storage subsystem. In order to model total energy consumption of the device, we use the following: total energy Eₜₒₜ=P_{ON}×t_{ON}+P_{OFF}×t_{OFF} where P_{ON} and P_{OFF} are power usage for ON and OFF power states, respectively, and t_{ON} and t_{OFF} are the corresponding ON-time and OFF-time, respectively. The error estimates for ON and OFF power states are ΔP_{ON} and ΔP_{OFF}, respectively. We assume that ΔP_{OFF}<<ΔP_{ON} because OFF represents a single physical state and ΔP_{OFF} is approximately 0. Therefore, the dominant approximation errors for total energy usage come from ΔP_{ON} and Δt_{ON}. ΔP_{ON} and P_{ON} are likely to reflect systematic errors when policies change. t_{ON}, on the other hand, is expected to be highly dependent on the policy itself. When analyzing our simulation results, one should verify that t_{ON} indeed contributes the lion's share of the storage energy. This done, the analysis can then focus on comparing one energy saving policy with another energy saving policy rather than on obtaining the absolute energy savings of any one policy.

A description will now be given of design features of the present principles, in accordance with an embodiment of the present principles.

Regarding the design features, a description will now be given regarding a block-swap operation, in accordance with an embodiment of the present principles.

To support block swapping, a swap-lock was introduced as a special locking mechanism. Swap-lock does not change the content of a locked logical block before and after the locking procedure. That is, a swap lock behaves like a read lock from the perspective of client code (a logical block), allowing other client reads to proceed from cached content. However, internal reads and writes for the swap behave as write-locks for the physical block addresses involved.

Block swapping protocols also take care to avoid data races and maintain cache consistency as I/O operations traverse layers of caches and disks. Consider a block swapping policy trying to initiate a background block-swap operation after a client read on LBA l₁. When the read finishes, the content is known, but other read-locks may exist, so AccNode 620 checks the number of read-locks on this block. If there are no other read-locks existing, then the read-lock may be upgraded to a swap-type lock. Thereafter, AccNode 620 determines which disk the block should swap to and sends a message to the corresponding storage wrapper module for a pairing block l₂. If l₂ maps to a free block p₂, then the read of p₂ and ensuing write to p₁ can be skipped. Swapping a client read into free space on another physical device can optionally create a copy of the block instead of a move. However, if p₂ is not known to be a free block, swap-locked block is passed to the block redirector to request a block-swapping operation. Upon receiving the request, block redirector 630 first issues one background read for l₂ and after the read returns successfully, block redirector 630 issues two background writes. When these block swapping writes are done, the block map points l₁ and l₂ at their new physical locations, content cached for swapping can be removed, and swap-locks on l₁ and l₂ are dropped. Swap locks also allow write-offloading to be implemented conveniently, with similar shortcuts when writing to free space is detected.

Regarding the design features, a description will now be given regarding write-offloading support, in accordance with an embodiment of the present principles.

Write-offloading schemes shift the incoming write requests to one of the ON disks temporarily when the destination disk is OFF and move written blocks back when the block is ON later (e.g., a disk is ON due to an incoming read request). This approach requires a provisioned space to store offloaded blocks per disk and needs a manager component like a volume manager to maintain the mapping of offloaded blocks and the original locations. In our simulation, we achieve write work-load offloading with a block swapping approach. Maintaining permanent block location changes may impose a higher mapping overhead for the volume manager. However, such overheads can be mitigated by introducing the concept of data extent (i.e., a sequence of contiguous data blocks) at the volume manager that is then instructed to swap two data extents rather than two data blocks among two disks. We develop a series of block swapping policies using the simulator, that for low additional system load result in fast dynamic “gearing” up and down of the number of active disks.

Regarding the design features, a description will now be given regarding a two-queue model, in accordance with an embodiment of the present principles.

We implemented two queues in the message queuing model in the simulator that could handle foreground and background messages within separate queues at each node. Such a scheme has been shown to be particularly useful for storage when idle time detection of foreground operations is used to allow background tasks to execute. This in turn, led to implementing more complex lock management, since locks for background operations were observed to interfere with the fast path of client (foreground) I/O. In particular, it was useful for the initial read-phase of a background block-swap to take a revocable read lock. When a foreground client write operation revokes this lock, the background operation can abort the block-swap transaction, possibly adopting an alternate swap destination and restarting the block swap request. This approach resolved issues of unexpectedly high latency for certain client operations.

Also, simulating background tasks during idle periods in foreground operations poses some complexity in correctly and efficiently maintaining global simulation time and a global priority queue view of the node-local queues. We next describe our optimization to address this issue.

Regarding the design features, a description will now be given regarding a two-queue model optimization, in accordance with an embodiment of the present principles.

Typically, time-dependent decision making is simulated using some form of “alarm” mechanism. When we have frequently arriving foreground operations using alarms as inactivity timers, it causes wasteful push and pop operations on the global message queue that can slow down the simulation. To overcome this issue, we have augmented the global priority queue with a data structure including dirty set entries for: (1) simulated nodes whose highest priority item must be unconditionally re-evaluated during the next time step; and (2) simulated nodes whose highest priority item must be re-evaluated conditional on the global simulation time advancing past a certain point. These dirty set entries are simulation optimizations that can allow some time-dependent policies to bypass a large number of event queue “alarm” signals with a more efficient mechanism. A node-dirtying scheme can help the efficiency of graph operations to determine the global next event as follows: many operations on a large priority queue are replaced with a smaller number of fast dirty set operations on a small dirty set. At each time step, nodes in the dirty set are checked to reach consensus about the minimally required advance of global simulation time.

The price paid for this efficiency is that a sufficient, correct logic for creating dirty set entries is difficult to derive. We analyzed all possible relative timings of content on foreground and background queues with respect to a node's local time and global simulator time in order to distill a simple set of rules for creating dirty set entries. The analysis is primarily governed by the restriction of never using “future” information for node-local decisions, even though the simulator may have available events queued for future execution. “Alarm” based approaches are easier to implement for different scenarios and present fewer simulation correctness issues. One should use alarms if they constitute only a small fraction of the requests.

A description will now be given of an approximation in EEffSim, in accordance with an embodiment of the present principles.

We use a single AccNode 620 and Block Redirector 630 in our framework. A more accurate abstraction might allow multiple access nodes for scalability, and the logical to physical block mapping may in reality be distributed across multiple nodes. However, having two objects allows us to get approximately the right number of network hops, which is sufficiently accurate given that device node access times are modeled with much less fidelity.

In the regime where latency is governed by outlier events that absolutely have to wait for a disk to spin-up, we consider approximation errors in t_{ON} as negligible. Since disk spin-up is on a time scale 3-4 orders of magnitude larger than typical disk access times, errors on the level of milliseconds for individual I/O operations contribute negligibly to block swapping policies governing switching of the disk energy state. This approximation holds well in the low-IOPS limit (design goal 4), where bursts of client I/O do not exceed the I/O capacity of the disk, and accumulated approximation errors in disk access times remain much smaller than t_{OFF→ON}.

A description will now be given of the algorithm we use for energy efficiency in a distributed storage system, in accordance with an embodiment of the present principles.

We begin with a short summary of the major features of the current implementation, with more comments on how simplified aspects can be generalized and improved. We focus on features derived from the following line of reasoning. In reactive, online algorithms with a high cost for making any decision (replica creation, full block swap), the swap policy will only suggest a change when “something is bad”. Thus, when new data locations arise, it is a signal that we thought storing some item in that location was “better” than anything available currently. Therefore, it makes sense to prioritize most-recently created locations as being somehow “better” than older locations, since they reflect the latest attempt of the system to adapt. Thus, a replica list 233 can be maintained to reflect this notion. In essence, the old concept of “primary location” is generalized to be the location currently at the head of the replica list 233, which is a dynamic location instead of the usual statically assigned storage location. While overall operation should obey the above reasoning, extensions can exceptionally allow the system to recognize bad decisions and make corrections. The following section describes some of the details surrounding maintenance of the replica list 233.

A description will now be given of the algorithm we use for energy efficiency in a distributed storage system, in accordance with an embodiment of the present principles.

Regarding the algorithm we use for energy efficiency in a distributed storage system, a description will now be given regarding an EEffSim implementation, in accordance with an embodiment of the present principles.

Our initial efforts investigated a system whose only mechanism for adaptation was by full block exchange. Performing block exchanges could be done more efficiently in an online setting, since the most recently used (MRU) block was already cached, and the exchange could be done in the background out of the client fast-path. The basic mechanisms and a number of optimizations to get reasonable QoS in such a system involve some simple “block swap policies”. A block swap policy is given a logical address whose physical address is on one destination disk as an input, and replies with a destination disk that might be a better destination for the operation, at the current time. If the block swap policy returns the same disk (or fails), nothing special need be done. A block swap policy can be used to direct writes or (on the return path to the client) reads. The block exchange can be performed in the background with little effect on the fast-path of the client operation. We found it helpful to introduce custom locking (notably with readable write-lock states for items whose values we could guarantee are correctly supplied from a small memory cache).

Some major characteristics of our system are: (1) Online adaptation on a per-request basis; (2) Simple reactive block swap policies; (3) A strong preference to replace full block exchange with replication, along with a decoupled garbage collector; and (4) No static notion of a “primary location” for any block.

One characteristic of our system is the online adaptation. Every request is redirected based on “current” statistics, without an epoch. In essence, the notion of “epoch” is delegated to the statistics gathering units, whose windowing or time averaging behaviors can be tuned for good performance of the online decision-making.

The most successful of a wide variety of algorithms we tried had the common characteristic of doing nothing if the system was in an acceptable resource utilization state. This we related to our observation that background swap operations, even with highly optimized efficiency tweaks, could yield surprisingly bad behaviors, even if the overall percentage of swaps was low. Often people have adopted a fixed limit, say 1-5% and argue that since background operations are such a small percentage they can be ignored. We found it difficult to establish any such fixed limit since different swap policies will have different sensitivity background swapping. We found that “clever” tricks that attempted preemptively swapped blocks to move the system “faster” toward low energy usage inevitably failed for some (or most) client access patterns.

“Reactive” block-exchange algorithms performed particularly well: when things go bad (too much or too little I/O to some disk, and so forth), perform a block exchange to reduce the badness. Better algorithms maintained a small amount of state, and could remember what was bad, and what was done to fix it. This response memory allows one to introduce hysteresis in the response, where a reactive fix up persists until either reducing a bad load to somewhere below (/above) the triggering level of an over (/under) load, or until success is achieved in turning off an under-loaded disk. Without a fix-up state and hysteresis, fix-up decisions were observed to be highly dependent on statistical noise, particularly when average load factors were nearly identical, leading to counterproductive block exchanges (e.g., from disk A to B, and very soon after from disk B to disk A). Here we will present one particular example of such an algorithm, where by setting a number of load-related thresholds one can create either an aggressive block-swapping policy or a more conservative one. For very high client loads, we found a conservative policy worked better. While there is no single policy that maintains extremely good performance for all types of client behavior, we have found that even applying a conservative policy always worked very well, adapting quickly to attain an energy-efficient configuration with little QoS degradation.

We then introduced free space, where a block exchange with a free space block degenerates into a simple write redirection or a plain replica creation. Reducing the impact of background swapping in this fashion we found to be extremely helpful. Several new components support free space and copies. A replica list 233 is maintained, which lists in order of priority the different physical destinations for every logical block. A background garbage collector 242 asynchronously regenerates system free space, either by erasing superfluous replicas or by explicit block movement. Also, a load balancer 221 is useful to direct client reads to the most appropriate replica.

A strong preference for replication+GC is one characteristic feature of our system. Garbage collection ideally includes simply deleting unneeded copies, but additionally may perform block copying. In effect, garbage collection drastically reduces the coupling between client I/O and background full-exchange I/O, shifting the elided movement/collection of least recently used (LRU) blocks to the garbage collector 242. Importantly, the garbage collector 242 now runs independently of the client I/O, and can monitor disk load explicitly so as to present an even lower impact upon ongoing client I/O, and can do more involved system maintenance as disks are very lightly loaded (or fully idle, before a transition to a low-power state).

Another characteristic is that with storage adaptation based on full block-exchange, the concept of “primary location” really becomes fully dynamic. There is no block whose location cannot be swapped. What we introduce is a mechanism to maintain the importance of different replicas. We do this by introducing an ordered replica list, rlₜ (also interchangeably denoted herein by the reference numeral 233) of replicas for any logical block, where the “most important current location is a strongly preferred (possibly unique) target during load balancing of incoming client requests. In effect rlₜ[0] becomes a time-dependent set of primary locations. This list is also used by the garbage collector 242 to guide garbage collection. Garbage collection prefers to garbage collect blocks with more copies, and deletion of the last element rlₜ, is the preferred operating mode. The data structure used in the simulator reflects a possible distributed implementation of the replica chain.

Algorithm 1 will now be present, which is directed to job-base policy trigger creation/destruction conditions. The particular thresholds are the “aggressive” setting, which work well for low-IOPS, such as client I/O generated from traces.

Algorithm 1 Job-base policy-trigger creation/destruction
conditions. The particular thresholds are the “aggressive”
setting, which work well for low-IOPS, such as client
I/O generated from traces.

| | |
|---|---|
| 1. | If the target disk I/O rate was too low (vₛ < 0.4Cₛ), create a job |
| | swapping from s to the highest-IOPS ON disk d with vₛ < v_{d} < 0.9C_{d} |
| | if possible. Remove this job if disk s turns OFF (or vₛ > 0.45Cₛ). |
| 2. | If the target disk I/O rate was too high (vₛ > 0.95Cₛ), create a job |
| | moving to the highest-IOPS ON disk d with v_{d} + 0.1Cₛ < 0.95C_{d} |
| | if possible. Remove this job when vₛ < 0.90Cₛ or v_{d} > 0.90C_{d}. |
| 3. | If the target disk I/O rate was too high (vs > 0.95Cs), create a job |
| | swapping s to a most active OFF disk t, turning it on. Remove this |
| | job when vs < 0.90Cs or v_{d} > 0.90C_{d}. |

Algorithm 1 presents a simple swap policy that functioned reasonably for a number of test cases. Actually, we have implemented and tested at least 15 swap policies with various features, and note here that additional features such as client-specific destination selection was one additional feature that we demonstrated to be effective. For example, we implemented spread limits, which heavily penalize swapping a block from a client to a disk outside its footprint of significantly populated disks. We also have the information to perform near optimal packing of clients onto disks using as input the time-correlation information of any two clients (for example, two clients that are highly probably never active simultaneously can be co-located without detriment, and so forth). Besides an example of an online swap policy, we now wish to describe the functioning of two additional core components by describing simplistic, but reasonable, implementations: the replica list 233 (Algorithm 2) and the load balancer 221 (Algorithm 3).

Algorithm 2 Replica list handling. This is a simple version which
can be modified to obtain more robust implementations.

| | |
|---|---|
| 1. | A client read that results in a block swap has the swap destination |
| | moved to the head, rlₜ[0]. A client write results in a new |
| | replica chain rl[0 . . . r − 1] ordered by current system |
| | resources ordered according to the load balancer sad swap policy |
| | decisions. In the event of full block swap (rare lack of frees pace |
| | for the “LRU” destination), the selected in replica may be |
| | left as is (simplest implementation) or moved to the tail position or |
| | its rlₜ. |
| 2. | The load balancer (client request redirection to physical location) |
| | strongly prefers to shunt load to the primary replica rlₜ[0] |
| | and disfavors sending requests to OFF devices. It may, for example in |
| | cases of high load or destination device being currently OFF, wish to |
| | direct load to alternate copies. However, particular disks or machines |
| | that have been identified desirable to shut down should only receive |
| | client traffic if they are the only ON replica currently available. In |
| | this case, the block swap policy will attempt to create a copy in a |
| | currently better location. |
| 3. | A client request directed by the load balancer has no effect on the |
| | replication list. |
| 4. | The garbage collector should prefer to free up: (a) highly duplicated |
| | blocks, (b) blocks near the tail-end rl[i ≧ r] of the |
| | replication list, and (c) “LRU” blocks. These types of garbage |
| | collection can involve only metadata operations. However, if a disk is |
| | full and no such blocks are available for fast deletion, the garbage |
| | collector may resort to moving primary replicas elsewhere, so |
| | progress can always be made. |

Algorithm 3 Load balancer refinement (example of
step 2 of Algorithm 2)

| | |
|---|---|
| 1. | The load balancer (LB) first considers all replicas, prioritizing them |
| | according to a combination of position within rlₜ, and a measure |
| | of the I/O resources available at each copy destination to form a first |
| | scored list L of candidate destinations. OFF disks are assigned a low |
| | resource availability. |
| 2. | It consults the set of longer term swap hint information from |
| | the Job-based scheduler. |
| 3. | Scores are penalized for disks involved in swap hint information in |
| | accord to swap direction (swap to/from) and intent (reduce overload/ |
| | shut down disk). A disk being swapped away from with intent to shut |
| | down is heavily penalized, and a disk being swapped to may |
| | optionally receive a penalty to their scores. |
| 4. | If there are ON-disks in L with sufficiently high scores, prune all |
| | other destinations from L. |
| 5. | Select a destination from L, while attempted to distribute the selection |
| | probability as a function of the score. This could be done, for |
| | example, by random selection, random selection proportional to some |
| | estimate of I/O load availability at each device, or by instantiating |
| | a round-robin procedure to create a regular striping pattern for all |
| | I/O from a particular source disk that counts how many I/Os have |
| | been redirected to each destination disk during the current statistical |
| | period. |

We now focus instead focusing on how to update and use the replica list rlₜ, also interchangeably denoted by the reference numeral 233 as noted above. Once again, we use the term “swap” to indicate either a full block exchange or, if free space was available, a replica-creating copy operation, and r is the minimal accepted replication factor (one so far, but 3 for simulations of Hadoop storage). One method to maintain the replica list 233 that we found particularly simple and useful is presented in Algorithm 2.

Extending step 1 of Algorithm 2 to support creating a write replica chain requires a light modification of the original swap policy API to be able to request an ordered list of swap destinations. This ordering occurs quite naturally, since most policies use some sort of scoring function to rank all available destinations internally anyway.

It can be particularly beneficial in step 2 of Algorithm 2 for the load balancer 221 to dynamically redirect to (additional) non-primary replicas when the statistics collection interval is larger (we used 1 second in the simulator, but we are using 10 seconds for our Hadoop implementation, noting that the present principles are not dependent upon these values or any other specific value used here, as they are specified for illustrative purposes and can be readily substituted depending upon the specific implementation, as readily appreciated by one of ordinary skill in the art, given the teachings of the present principles provided herein). Otherwise, too many requests can end up being redirected to one node. In these cases, it may also be possible to make reasonable estimates about redirected load during the progress of the statistics distribution epoch (e.g., 10 seconds). The concept of I/O destination for the load balancer 221 and swap policy and swap policy hints then is generalized to include a set of destinations, with possible support to create data layouts such as regularly striped as opposed to other choices like probabilistic selection according to resource availability (some estimate of I/O load at the device).

Consider step 3 of Algorithm 2. Notice that it is the combination of the block swap policy (used for both full swaps, for replica destination decisions, and for write redirection) with the replica list 233 which yields load balancing of elegant simplicity. When one operates in a limit of frequent statistics updating, a load balancer 221 which directs all incoming client reads to the first found replica located on an ON device (often this is the primary replica) can in fact work very well, in spite of appearing to be non-optimal. What actually happens is that the load balancer 221 decision enters the swap policy, and if the load balancer (often primary) location is ever overloaded, the block swap policy (as implemented by the swap policy 222) then kicks in to decide a better destination, which will later become the new primary replica. If the better destination already has a secondary replica, then the client operation is redirected there immediately, “as if” the load balancer 221 had made the decision and modified rlₜ, itself However, having the swap policy decisions fully control the election of primary replicas results in a clean division of labor between the load balancer 221 and swap policy 222. Only in the rare case when the better destination has no free space and requires a full block exchange are the simple load balancing and swapping policies actually going to increase the load on an overloaded disk, and this is a rare occurrence if enough replica space has been allocated and the garbage collector 242 is working well.

In step 4 of Algorithm 2, note that identifying “LRU” blocks requires optional system components to track such sets of blocks. We use an efficient content-less LRU-like storage wrapper for each disk in FIG. 6 to provide such functionality. Of course, other forms of block frequency information are equally acceptable. Garbage collector 242 may also use client-specific statistics to influence which physical replicas get garbage collected. Thus far, we have been using a very simple garbage collection procedure able to delete any superfluous replicas and have not observed any actual test cases that require a more complex implementation. Nevertheless, for a production system, one should have a garbage collector 242 that is always able to make progress, and that operates with some awareness of replica priority as maintained in the replica list rlₜ.

Returning to the load balancing of steps 2 and 3 of Algorithm 2, we saw that when disk spin-ups enter the picture, “daily” clients load balanced by redirected always to the primary replica led to undesirable behavior. For example, redirecting all co-located loads to a single primary destination disk for many seconds can itself result in overload on that frequently selected destination disk. It would be better to load balance amongst all replicas whose disks have not been flagged for turning OFF. This load balancing could direct the load in proportion to the best estimate of available I/O bandwidth at the various destinations, even if those estimates may be several seconds stale. In the case where the load balancer 221 is persistently favoring a secondary replica above the primary replica, it then makes sense to break step (3) of Algorithm 2 as stated above and have the load balancer 221 itself promote that secondary location to become the primary replica.

A better load balancer than the simple one described within Algorithm 2 for maintaining the replica list 233 should have the following behavior: (1) The ability to score multiple possible replica disks according to estimated I/O resource availability; (2) Incorporation of replica priority (position within rlₜ) into the score; (3) Incorporation of disk OFF/ON state at the destinations into the score; (4) Awareness of persistent swap policy intentions (in general, any persistent internal state of the swap policy, such as the set of jobs within a jobs-based swap policy) and a method to incorporate this knowledge into the scoring; and (5) Optionally, the load balancer 221 may retain some small persistent state so as to better allow behaviors such as selecting client request destinations in accordance in proportion to a score or probability distribution.

Reasonable behavior for actual traces of client I/O could be achieved by skipping balancing entirely and directing client reads to the primary replica only. Apparently, swap policies are able to innately generate sufficient “random striping” that load balancing can be achieved via the primary replica only. Nevertheless, we generated synthetic clients that made apparent the necessity of doing real load balancing along the lines of Algorithm 3, since in some cases convergence to a good set of primary replicas using a simple swap policy seemed not to occur. These difficult cases involved clients with extremely bursty behavior, high IOPS and large working sets.

In implementing step 3-5 of Algorithm 3, it is useful to maintain a list of counts within each statistical collection period, and counts of client requests redirected to each physical destination. This can be used for two purposes: first, to partially correct estimated load factors (which may have limited success if Access Node functionality is distributed); and second, to implement selection procedures that have non-random behavior. For example, within one statistical period, it may be reasonable to always send the first N requests to the primary replica. Alternatively, one can relax steps 2-3 of Algorithm 3 by having the load balancer 221 exceptionally increment the rlₜ priority of a disk whose score for a selected disk is significantly higher that the score for the disk housing the primary replica.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A system for providing an energy efficient block layout in a distributed storage system, comprising:
a client request receiving device for receiving incoming client requests to perform any of a read and write operation for a data block,
at least one memory device for storing ordered replica lists and a swap policy, each of the ordered replica lists for a respective one of stored data blocks in the distributed storage system and having one or more entries, each of the entries specifying prioritized replica location information for the respective one of the stored data blocks, at least a portion of the prioritized replica location information being associated with physical storage devices and respective priorities for the physical storage devices;
a load balancer for scoring and selecting an original location for the data block specified in a given one of the incoming client requests responsive to the prioritized replica location information and a policy of favoring any of the physical storage devices that are fully operational and have locations of higher priority in the ordered replica lists; and
wherein the swap policy evaluates the selected original location for the data block responsive at least in part to the prioritized replica location information and estimated input and output workload at locations of the physical storage devices to decide upon at least one alternate location for the data block responsive to the write operation requested for the data block, and to decide to place the data block at the at least one alternate location responsive to the read operation requested for the data block.

2. The system of claim 1, wherein the swap policy decides upon the at least one alternate location for the data block responsive to the write operation requested for the data block, by creating a new ordered replica list for the data block.

3. The system of claim 2, wherein each of the ordered replica lists has at least one data location therein where a replica of the data block is stored thereat, and wherein the new ordered replica list is created for the data block with the replica of the data block located at each of the data locations in the new replica list.

4. The system of claim 2, wherein the swap policy decides upon the at least one alternate location for the data block responsive to the write operation requested for the block, by erasing from the new ordered replica list for the data block previous entries that existed in a previous version of the ordered replica list for the data block.

5. The system of claim 1, wherein the swap policy decides to place the data block at the at least one alternate location responsive to the read operation requested for the data block, by initiating either a replica creation background process for the data block or a block swap background process for the data block, such that that a particular alternate location ultimately assigned for the data block has the highest priority in the ordered replica list for the data block.

6. The system of claim 1, wherein at least one of the ordered replica lists is configured to include more than one entry for at least one of the stored blocks corresponding thereto to distinguish more desirable replica locations from less desirable replica locations based on the prioritized replica location information.

7. The system of claim 1, wherein each of the replica lists has at least one data location therein where a replica of the data block corresponding thereto is stored thereat, at least one of the replica lists for at least one of the stored data blocks has more than one data location therein, and the system further comprises:
a free space tracker for tracking free space in the distributed storage system; and
a garbage collector for regenerating free space responsive to the prioritized replica location information to delete excess replicas in less desirable data locations first.

8. The system of claim 1, wherein the swap policy renders some swap decisions for the stored data blocks based on swap policy data, the swap policy data including swap job entries, each of the swap job entries specifying at least one source location, at least one alternate destination location, and a specification of an intent of a corresponding swap job applicable to a given one of the stored blocks.

9. The system of claim 1, wherein each of the replica lists has at least one data location therein where a replica of the data block corresponding thereto is stored thereat, at least one of the replica lists for at least one of the stored data blocks has more than one data location therein, and wherein the load balancer disfavors sending read operations to data locations in a corresponding one of the ordered replica lists when any available persistent swap policy information indicates that a corresponding one or more of the physical storage devices relating to the data locations is intended to be moved to a more idle state.

10. The system of claim 1, wherein each of the replica lists have at least one data location therein where a replica of the data block is stored thereat, and at least one of the replica lists for at least one of the stored data blocks has more than one data location therein, and wherein the load balancer is configured to direct all of the incoming client requests to a given data location having a highest priority and being associated with a particular one of the physical storage devices which is fully operational.

11. A method for providing an energy efficient block layout in a distributed storage system, comprising:
receiving incoming client requests to perform any of a read and write operation for a data block,
storing, in at least one memory device, ordered replica lists and a swap policy, each of the ordered replica lists for a respective one of stored data blocks in the distributed storage system and having one or more entries, each of the entries specifying prioritized replica location information for the respective one of the stored data blocks, at least a portion of the prioritized replica location information being associated with physical storage devices and respective priorities for the physical storage devices;
performing load balancing by scoring and selecting an original location for the data block specified in a given one of the incoming client requests responsive to the prioritized replica location information and a policy of favoring any of the physical storage devices that are fully operational and have locations of higher priority in the ordered replica lists; and
wherein the swap policy evaluates the selected original location for the data block responsive at least in part to the prioritized replica location information and estimated input and output workload at locations of the physical storage devices to decide upon at least one alternate location for the data block responsive to the write operation requested for the data block, and to decide to place the data block at the at least one of the alternate locations responsive to the read operation requested for the data block.

12. The method of claim 11, wherein the swap policy decides upon the at least one alternate location for the data block responsive to the write operation requested for the data block, by creating a new ordered replica list for the data block.

13. The method of claim 12, wherein each of the ordered replica lists has at least one data location therein where a replica of the data block is stored thereat, and wherein the new ordered replica list is created for the data block with the replica of the data block located at each of the data locations in the new replica list.

14. The method of claim 12, wherein the swap policy decides upon the at least one alternate location for the data block responsive to the write operation requested for the block, by erasing from the new ordered replica list for the data block previous entries that existed in a previous version of the ordered replica list for the data block.

15. The method of claim 11, wherein the swap policy decides to place the data block at the at least one of the alternate locations responsive to the read operation requested for the data block, by initiating either a replica creation background process for the data block or a block swap background process for the data block, such that that a particular alternate location ultimately assigned for the data block has the highest priority in the ordered replica list for the data block.

16. The method of claim 11, wherein at least one of the ordered replica lists is configured to include more than one entry for at least one of the stored blocks corresponding thereto to distinguish more desirable replica locations from less desirable replica locations based on the prioritized replica location information.

17. The method of claim 11, wherein each of the replica lists has at least one data location therein where a replica of the data block corresponding thereto is stored thereat, at least one of the replica lists for at least one of the stored data blocks has more than one data location therein, and the method further comprises:
tracking free space in the distributed storage system; and
regenerating free space in the distributed storage system responsive to the prioritized replica location information to delete excess replicas in less desirable data locations first.

18. The method of claim 11, wherein the swap policy determines whether the original location specified in the incoming client requests is consistent with persistent swap policy data and most recent system load information.

19. The method of claim 11, wherein each of the replica lists has at least one data location therein where a replica of the data block corresponding thereto is stored thereat, at least one of the replica lists for at least one of the stored data blocks has more than one data location therein, and wherein the load balancing disfavors sending read operations to data locations in a corresponding one of the ordered replica lists when any available persistent swap policy information indicates that a corresponding one or more of the physical storage devices relating to the data locations is intended to be moved to a more idle state.

20. The method of claim 11, wherein each of the replica lists have at least one data location therein where a replica of the data block is stored thereat, and at least one of the replica lists for at least one of the stored data blocks has more than one data location therein, and wherein the load balancing directs all of the incoming client requests to a given data location having a highest priority and being associated with a particular one of the physical storage devices which is fully operational.
